(19) United States
(12) Patent Application Publication
(10) Pub. No.: US 2010/0195083 A1
(43) Pub. Date: Aug. 5, 2010

(54) Automatic substrate transport system

(75) Inventors: Lionel Fulwood, St. George, UT (US); Greg Baxter, Palm Desert, CA (US); John Hart, Woodland Hills, CA (US); Raja B. Singh, Claremont, CA (US)

Correspondence Address: REED SMITH LLP, 101 Second Street, Suite 1800, SAN FRANCISCO, CA, 94105, US

(73) Assignee: WKK Distribution, Ltd.

(21) Appl. No.: 12/322,472

(22) Filed: Feb. 3, 2009

(51) Int. Cl. G03B 27/60

(52) U.S. Cl. 355/73

(57) ABSTRACT

An automatic substrate transport system having adjustable mechanisms to guide and float substrates on a film of air along a sloped path, permits smooth movement with significantly reduced contact and abrasion damage to imaged surfaces on the substrates. This allows for the transportation of any substrates including those coated with somewhat tacky coatings, thus reducing machine downtime associated with clearing line blockages, as well as transport mechanism cleaning.

### BACKGROUND OF THE INVENTION

1. Field of the Invention

The present invention relates generally to a system and method for exposing photolithographic materials on various substrates to light energy, and more particularly, to an automatic substrate handling and transport system to transport materials through a lamp exposure system.

2. Description of the Related Art

Traditionally, Printed Circuit Boards (PCBs) require either a photosensitive polymer to define the circuit pattern during manufacture, or a protective coating over the defined circuit paths after the circuit pattern is defined so that shorting does not occur during component assembly. The material used in both instances is a robust photo polymerized organic layer. Ultraviolet light is used to “activate” the polymerization process used in PCB manufacturing. A single PCB or a multiple set of images on a substrate called a panel is placed in a UV light exposure system for a period of time from a few seconds to up to one minute. The various areas for exposure and non-exposure on the UV light are defined using photolithographic artwork on a polyester sheet or glass, and normally mounted on a plate of glass within the exposure machine. Ultraviolet light is also used in industrial processes to cure or harden various polymerizable materials used in other manufacturing processes including electronics, such as adhesive layers, cover coats, bonding materials, conformal coatings, and the like.

In some instances, because a PCB coated with photosensitive material tends to be both tacky and rather photographically inert, the present art for automating the process using contact systems such as conveyor rollers or belts has met with limited success. The length of time to perform just the exposure function in an in-line process machine may take up to one minute. Add to this the time required for transportation and alignment of the substrates to the artwork for acceptable precision and yields, and the process becomes prohibitively long and cost ineffective.

Additionally, when processing substrates smaller than the maximum image area in the frame of the automated exposure apparatus, present art machines require the manual installation of shims that are the same thicknesses as the substrate being exposed. The function of the shim is to reduce glass breakage and bending toward the outside edges of the exposure frame, so that images are reproduced accurately. This manual shimming process introduces possible defects from particulates, dramatically increases job set up times, and contributes to the likelihood of human error.

As a result of these different problems, the most prevalent methodology in use today is to manually align the photolithographic artwork to the substrate using an eye loop for registration verification. The package comprising the aligned artwork and substrate is then placed in a manual machine vacuum tray, the tray being then evacuated and the whole system exposed to ultraviolet energy for periods up to one minute. In addition, prior systems using small vacuum pumps and small diameter vacuum tubing take too long to completely evacuate a chamber to provide flat, intimate contact between the photolithographic artwork and the panel for high speed operation.

### SUMMARY OF THE INVENTION

In general, the present invention is an automatic substrate handling and transport system to transport materials through a lamp exposure system. According to one embodiment, an automatic substrate transport and exposure system comprises a first platen, the first platen having holes on a top surface to allow forced air to produce an air film to support a substrate, a flipper module configured to receive a substrate from the first platen, and to rotate in order to flip the substrate, the flipper module having a top interior surface and a bottom interior surface, wherein the top and bottom interior surfaces provide an air film to support the substrate in the flipper module, and a second platen configured to receive the substrate from the flipper module, the second platen having holes on a top surface to allow forced air to produce an air film to support the substrate. The holes on the top surface of the first and second platens may also used to provide a panel hold vacuum. The system further comprises a first platen lift mechanism to lift the first platen into position for exposure, and a second platen lift mechanism to lift the second platen into position for exposure. The system may additionally include a first artwork holder and alignment system to hold and align photolithographic artwork to the substrate and a second artwork holder and alignment system to hold and align photolithographic artwork to the substrate. The system includes a first vacuum system to apply a vacuum to the first platen to bring the substrate and artwork close for exposure, and a second vacuum system to apply a vacuum to the second platen to bring the substrate and artwork close for exposure.

A first ultraviolet (UV) lamp exposure system provides UV light energy to the substrate in the first platen, and a second ultraviolet (UV) lamp exposure system provides UV light energy to the substrate. An infeed transport roller transports substrates to the first platen, and an outfeed transport roller transports substrates from the second platen out of the system. The infeed transport roller comprises one or more stops and two or more snubbers to align the substrate for handling by the first platen. The first and second platens comprise two or more retractable snubbers to align the substrate. The first and second platens are preferably tilted about 5 degrees downward to provide gravity movement to receive the substrate.

An automatic substrate transport system according to another embodiment includes a first platen, the first platen comprising an air film system to generate an air film to support a substrate, a flipper module configured to receive a substrate from the first platen, and to rotate the platen 180 degrees, the flipper module comprising an air film system to generate an air film on both sides of the substrate to support the substrate in the flipper module, and a second platen, the second platen comprising an air film system to generate an air film to support the substrate, wherein a substrate handled by the first platen, the flipper module and the second platen is transported through the system substantially on a film of air.

An automatic substrate transport and exposure system according to another embodiment comprises an air float supply system, a first platen connected to the air float supply system, the first platen having holes on a top surface to allow air from the air float supply system to create an air film to support a substrate, a flipper module connected to the air float supply system, the flipper module configured to receive a substrate from the first platen, and to rotate in order to flip the substrate, the flipper module having a top interior surface and a bottom interior surface, wherein the top and bottom interior surfaces have holes to allow air from the air float supply system to create an air film to support both sides of the substrate in the flipper module, and a second platen connected to the air float supply system, the second platen configured to receive the substrate from the flipper module, the second platen having holes on a top surface to allow air from the air float supply system to create an air film to support the substrate.

A method for automatically transporting substrates through a light exposure system according to an embodiment of the present invention includes conveying a substrate to a first platen, providing an air film to support the substrate in the first platen, such that the substrate is not substantially touching the surface of the first platen, conveying the substrate from the first platen to a flipper module, providing an air film on a top and a bottom interior surface of the flipper module to support the substrate, rotating the flipper module to flip the substrate 180 degrees, conveying the substrate to a second platen, providing an air film to support the substrate in the second platen, such that the substrate is not substantially touching the surface of the second platen, and conveying the substrate out of the system, wherein the substrate is transported through the system substantially on a film of air.

Another method for transporting substrates through an ultraviolet light exposure system according to an embodiment of the present invention includes activating an air float system, receiving a substrate, pre-aligning the substrate, conveying the substrate to a first platen, wherein the first platen provides an air float to support the substrate, aligning the substrate in the first platen and then de-activating the air float system, activating a vacuum hold down system, lifting the first platen into position for exposure, aligning artwork with the substrate, applying a vacuum between the substrate and artwork, exposing the substrate to ultraviolet light, de-activating the vacuum systems and re-activating the air float system, removing the vacuum, lowering the first platen, conveying the substrate from the first platen to a flipper module, wherein the flipper module provides an air film on a top and a bottom interior surface to support the substrate, flipping the substrate 180 degrees, conveying the substrate to a second platen, wherein the second platen provides an air float to support the substrate, aligning the substrate in the second platen then de-activating the air float system, and activating a vacuum hold down system, lifting the second platen into position for exposure, aligning artwork with the substrate, applying a vacuum between the substrate and artwork, exposing the substrate to ultraviolet light, removing the vacuums and activating the air float system, lowering the second platen, and conveying the substrate out of the system, wherein the substrate is transported through the system substantially on a film of air.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a first perspective view of one embodiment of a transport and exposure system according to the present invention;

FIG. 2 is a second perspective view of the system of FIG. 1;

FIG. 3 illustrates an exposure lamp system suitable for use in the present system;

FIG. 4 illustrates an infeed roller according to an embodiment of the present invention;

FIG. 5 illustrates a platen according to an embodiment of the present invention;

FIG. 6 illustrates the internal mechanics and electronics of the platen of FIG. 5;

FIG. 7 is a top view of the platen of FIG. 5;

FIG. 8 illustrates a platen lift mechanism according to an embodiment of the present invention;

FIG. 9 illustrates the platen lift mechanism of FIG. 8, with a platen;

FIG. 10 illustrates the vacuum features of the platen of FIG. 5;

FIG. 11 illustrates a flipper module according to an embodiment of the present invention; and

FIG. 12 illustrates an artwork holder and alignment system according to an embodiment of the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

In general, the present invention automatically transports, aligns, and exposes panels (substrates) coated with liquid or dry film type photo-imageable solder masks, or other photo-polymerizable materials. The entire process is automated, and requires only the initial set up to proceed. The transportation methodology, other than the initial in feed and penultimate out feed, moves the substrate-through the process on a film of air without damage to the sensitive coated surfaces.

An automatic substrate transport system having adjustable mechanisms to guide and float substrates on a film of air along a sloped (1-15 degrees) path, permits smooth movement with significantly reduced contact and abrasion damage to imaged surfaces on the substrates. This allows for the transportation of any substrates including those coated with somewhat tacky coatings, thus reducing machine downtime associated with clearing line blockages, as well as transport mechanism cleaning. It also allows the transportation of many different types of substrates, from thin and flexible to rigid and heavy panels.

The system also includes a novel vacuum evacuation system, permitting the rapid removal of air from the exposure frame, thus providing rapid intimate contact between the artwork and substrate for best exposure results. This involves both a unique plenum design for rapid air egress with a high volume gated valve pump system. This novel vacuum system increases the productivity of the automatic exposure system incorporating it, as well as increases the resolution of the system by eliminating defects caused by poor vacuum.

To obviate the need for the introduction of manual shims as discussed earlier, the system also provides for a unique exposure substrate platen that integrates an auto adjustable array of shims at the periphery of the platen, providing for the automated exposure of different substrate sizes without the tedious (and sometimes disastrous) manual mounting of shims. Because of its unique design, the present shim system eliminates particulates from normal shim materials, and results in a higher overall process yield.

The present automatic transport and UV exposure system is specifically designed to precisely align and produce images on solder mask (liquid or dry film photo resist) coated PCBs. However, it can be easily modified for use in the exposure of dry film photoresists, liquid coated photoresists, and other materials such as cover coats, conformal coatings and the like.

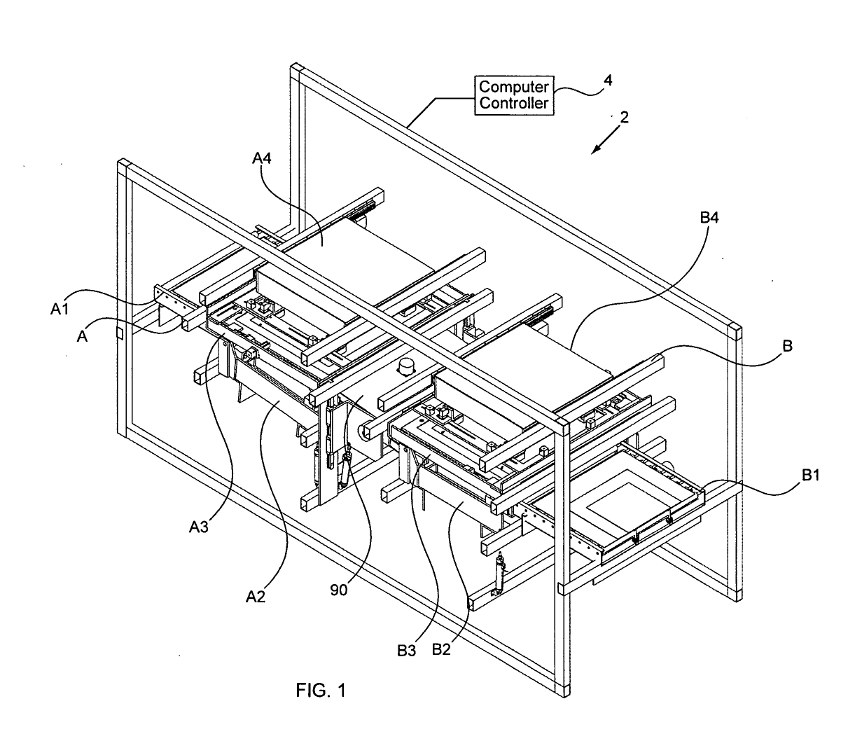

An automatic substrate transport system according to an embodiment of the present invention is illustrated in FIG. 1. The present invention will be described herein with respect to a specific system for processing PCB substrates. However, the teachings of the present invention can be applied to any substrates having photo-polymerizable material that need to be processed through a UV lamp exposure system. The present transport unit 2 can process PCB panels ranging in size from 356 mm×356 mm (14″×14″ or smaller) to 610 mm×720 mm (24″×30″). The present design, of course, can easily be modified to accommodate smaller or larger panels. The panel thickness capability ranges from a minimum of 0.2 mm (0.008″) to a maximum of 5 mm (0200″). The entire system can be computer controlled (via computer controller 4).

The transport unit 2 receives a panel to the Infeed Roller Assembly A1 from a manufacturer's conveyance device (on the left, not shown), pre-aligns it and holds a panel (outline shown) until it is needed at the Side A Exposure area A. The panel is then driven forward by the rollers onto the Side A Panel Platen A2 where it is suspended on a film of air (via air float supply system 86). The panel is more precisely pre-aligned, secured in place by changing the air flow mode from float to vacuum (via panel hold vacuum supply system 85), and then lifted up to the Artwork Alignment Module A3. Four CCD (or CMOS image sensor) cameras (not shown) with machine vision compare the positions of the artwork targets with the targets to be aligned located on the PCB. The alignment is corrected to the desired tolerance, full chamber vacuum is applied and the UV exposure takes place by activating the UV lamp module A4.

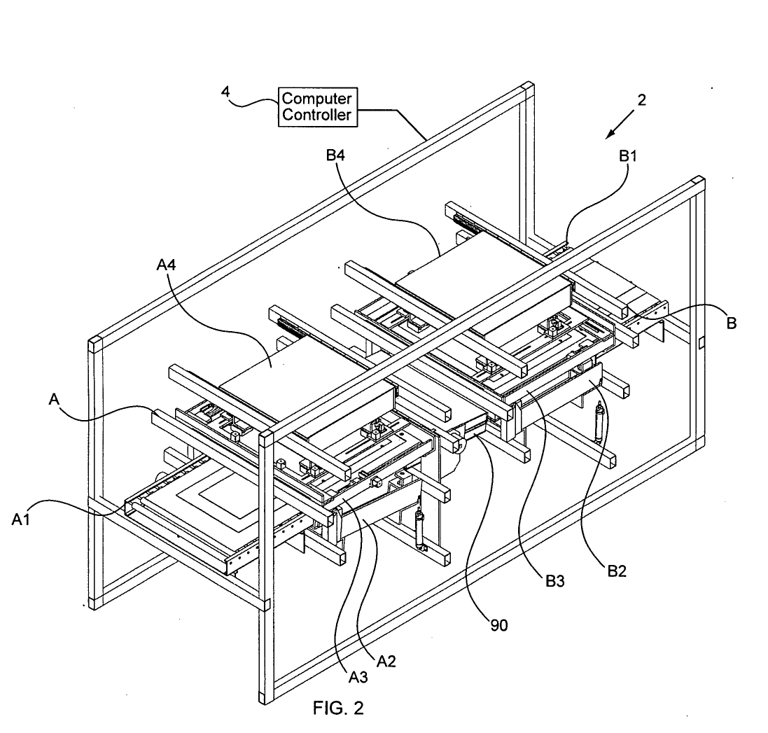

The Side A Panel Platen A2 is then lowered, the air flow is changed from vacuum to float, and the panel is again transported on a film of air into the Panel Flipping Module 80 where it is rotated 180 degrees, still supported on a film of air, and then subsequently loaded onto the Side B Panel Platen B2. The opposite side of the panel (Side B) is then aligned and exposed in the same manner as Side A. The panel is then conveyed to the Outfeed Roller Assembly B1 where it is driven out of the transport system 2 for the next process. FIG. 2 illustrates an alternate perspective view of the system of FIG. 1.

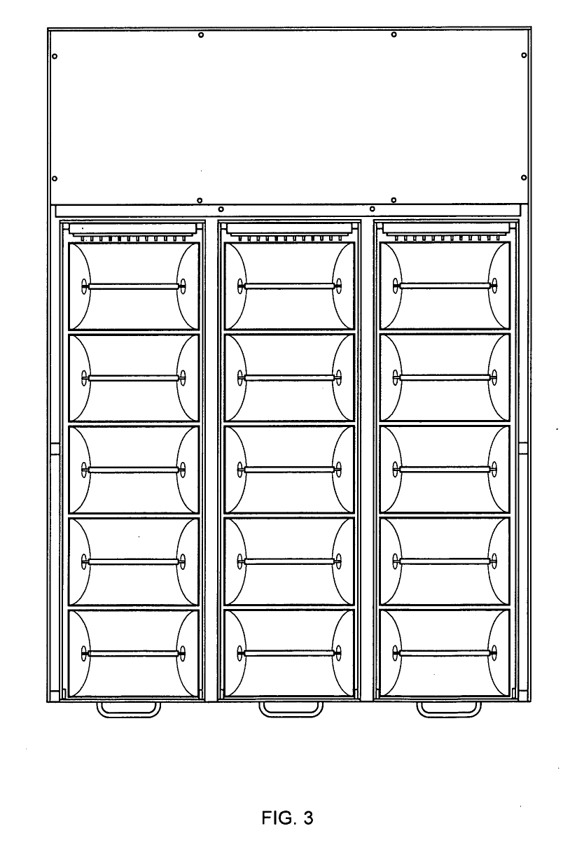

The UV lamp exposure modules A4, B4 may be any such modules as is known in the art, but is preferably a fast, high intensity flash lamp system, such as the system disclosed in co-pending application Ser. No. [ ], entitled LAMP SYSTEM PRODUCING UNIFORM HIGH INTENSITY ULTRAVIOLET LIGHT FOR EXPOSURE OF PHOTOLITHOGRAPHIC AND OTHER LIGHT POLYMERIZABLE MATERIALS, the disclosure of which is incorporated herein by reference. This lamp exposure module is illustrated in FIG. 3.

### Infeed and Outfeed Panel Transport Rollers

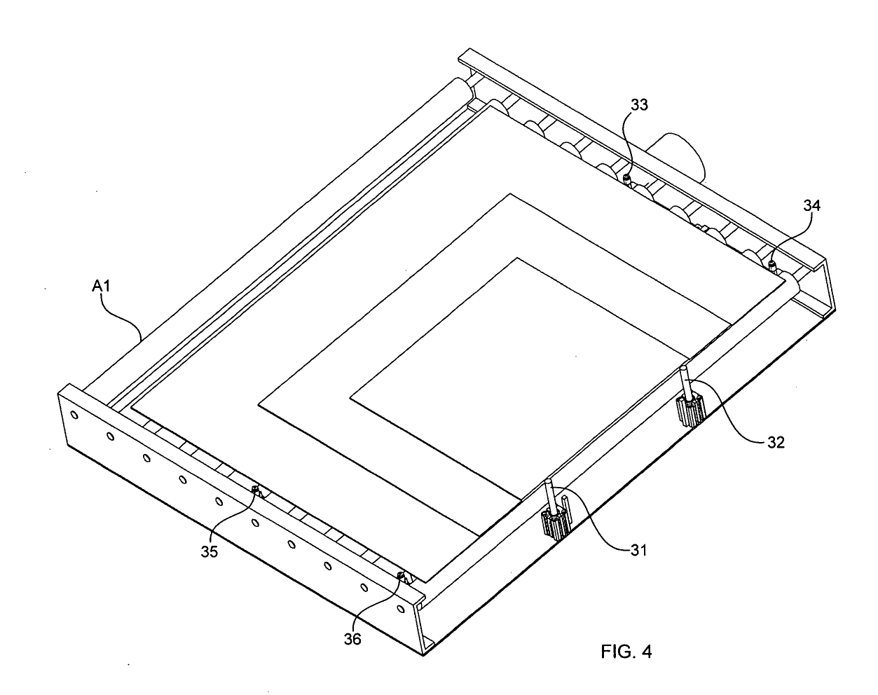

Normally, a panel accumulator module is mounted before the exposure station to handle any excess inventory during cleaning or during a machine failure. The Infeed Roller A1 performs a staging and pre-alignment task where the panel enters into the machine over a series of very smooth hardened rollers. The motorized rollers are set to match the speed of the manufacturer's conveyor. As shown in FIG. 4, once the system detects that a panel is fully on the in feed roller assembly, the panel is stopped via stops 31, 32, centered and squared from front to rear with motor driven “snubbers” 33, 34, 35, 36 and then slowly moved forward to a “panel staged” position.

The panel stops while the centering snubbers 33, 34, 35, 36 retract about 3 mm (0.125″) on each side to additionally guide the panel when it is moved into the Side A Exposure area A. FIG. 3 illustrates various panel outlines to show how a panel is pre-aligned.

The Outfeed Roller B1 performs a similar task to the Infeed Roller A1 except it drives the panel out the system's exit after the second exposure (Side B) is completed. It is essentially the same as the Infeed Roller A1, but without the additional snubbing mechanics since further panel alignment is not required.

### Side A and Side B Panel Platens

The Panel Platens A2, B2 are the hearts of each Exposure Station A, B. Each platen provide a combination of material transport, more precise panel pre-alignment, PCB holding for alignment and exposure, and a chamber vacuum system to place the panel in intimate contact with the artwork for UV exposure after alignment.

Tilt, Float, Pre-Align and Secure Panel for Exposure

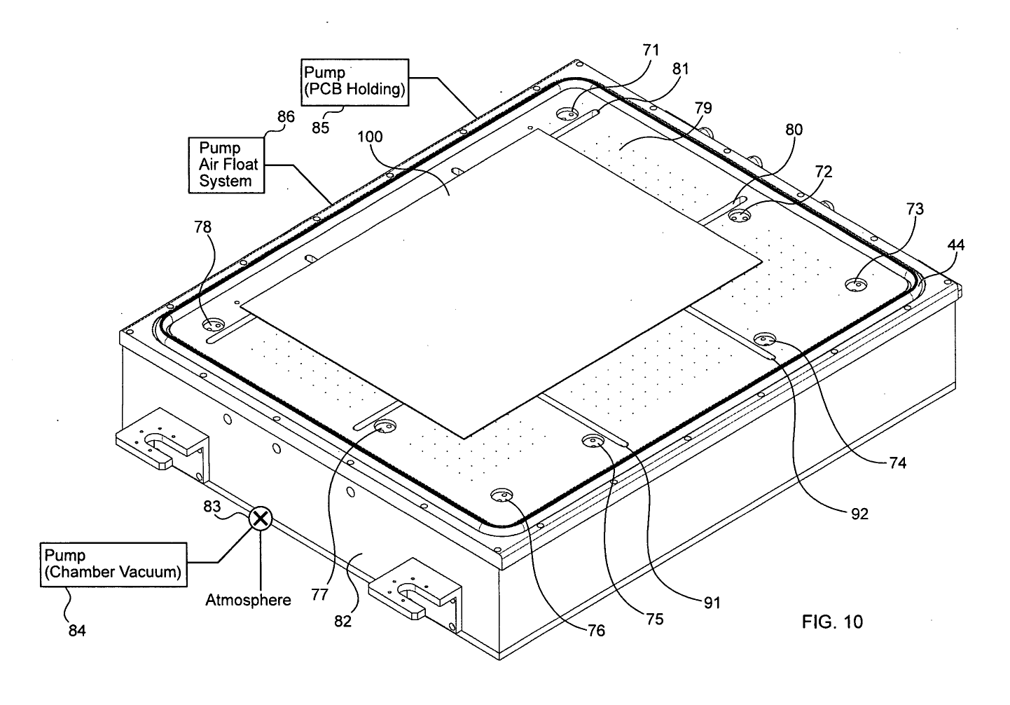

Each platen A2, B2 is tilted about 5 degrees downward to provide gravity movement to receive a PCB substrate. The panel platen A2, B2 has smooth, hardened surfaces plus an air bearing design that enables the panel to float with very low friction while moving downward by gravity. The air float system is similar to the concept used in an “air hockey” game, for example. The air float system includes an air pump (86; FIG. 10) to provide the necessary air flow to the platens and/or flipper module. Additional air pump systems may be provided, if desired. In a preferred embodiment, the platens A2, B2 are made from Teflon™ impregnated hard anodized aluminum to further prevent any material from sticking. This design prevents the panel's resist surfaces from being scuffed during transport. It also eliminates the need for pick-up and transport arms, reduces complexity and the air cushion provides additional cooling to the panel during transport and UV exposure.

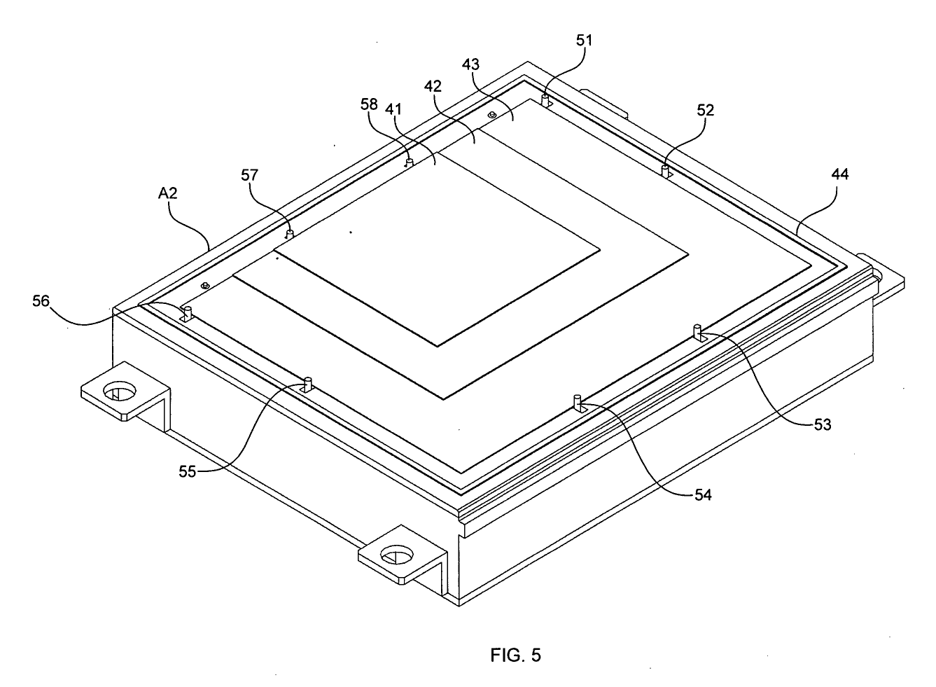

When a platen A2 is ready to accept a panel for processing, the Infeed Roller A1 propels the pre-aligned panel forward onto the floating downward-angled surface. As illustrated in FIG. 5, the platen A2 more precisely pre-aligns the panel to its center and leading edge, which for Side A is on the left, using similar motor driven snubbers 51-58 as the Infeed Roller A1. Once the panel is in proper position, the air bearing surface converts to a unique vacuum chuck (described below) to secure the PCB firmly in place and then the snubbers 51-58 completely retract. As shown in FIG. 5, the vacuum chuck has several zones 41, 42, 43 to securely hold small to large panel sizes effectively and houses an inflatable chamber vacuum seal 44 around the perimeter to enable chamber vacuum exposures for a variety of panel thicknesses.

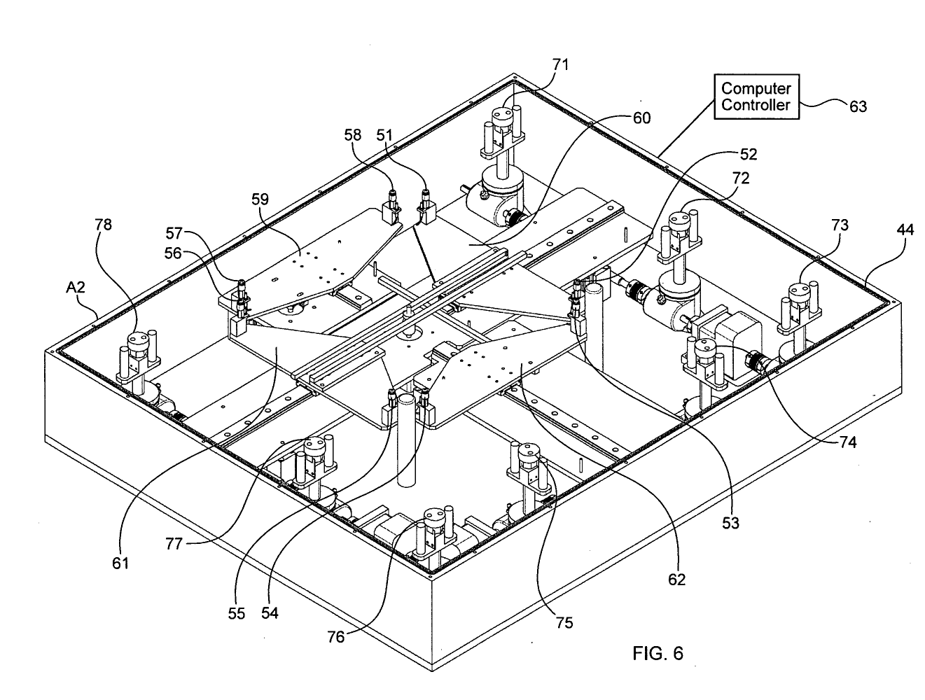

The internal mechanics of the platen A2 is shown in further detail in FIG. 6. The snubbers 51-58 are controlled by motorized plates 59-61, which slide along tracks as shown. In addition, automatic shims 71-78 are placed around the edge of the platen A2. In a preferred embodiment, the shims 71-78 are constructed as jack screws which can be raised and lowered, as described below.

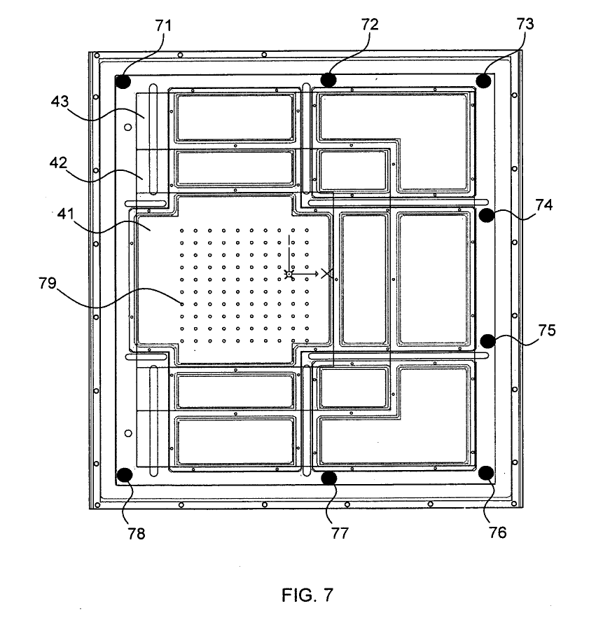

FIG. 7 illustrates a top view of the platen showing the air holes 79 which allow forced air from an air supply system 86 to provide the air film to float the panel. It can be seen that the air holes 79 are centered to support panels which are sized for any of the three zones 41, 42, 43. Also, it can be seen that open grooves on the top face are provided to allow the snubbers 51-58 to move back and forth, depending on the size of the panel. The air holes are used to float the panel during the handling process, and are used as a vacuum hold during the exposure process.

As discussed above, if a panel is smaller than the glass plate in the exposure module, when a vacuum is pulled to adhere the panel to the glass, the glass could break, since the edges of the glass have no support. In prior art systems, a manual shim (i.e. a template) would be created to fill in the gaps around a smaller panel. However, such a solution requires significant manual set-time up. It can also generate contaminants in the form of dust, debris, or adhesive residue.

Accordingly, each platen A2, B2 contains a uniquely designed feature that eliminates the need for manual panel shimming to prevent glass breakage during chamber vacuum exposures. FIGS. 6 and 7 depict the strategically placed motorized spacers [71-78] that automatically support large gaps between the tempered glass plate in the exposure module and the platen A2, B2 due to smaller panel sizes. The shims 71-78 protrude to approximately the same distance as the panel thickness (or more or less as desired), and enable uniform vacuum flow for quick draw down and quicker exposure cycles. This feature significantly reduces set-up times, particle defects because of tape used to hold down the inserted shims in the exposure area, and the potential for operator errors during the placement of shims. It also protects the expensive glass plate that holds the film artworks.

In operation, the shims 71-78 are raised and/or lowered as needed, depending on the size and/or thickness of the panel material. The settings can be computer controlled (via computer controller(s) 4 and/or 63) based on an operator's input of the size of the panel being processed. The shims could also be manually adjusted. The shims 71-78 can even be set slightly higher or lower than the panel thickness, if desired.

Also illustrated in FIG. 6 is further detail about how the centering snubbers 59-62 operate. The positioning of the snubbers is computer controlled, based on the size of the panels being processed. The snubbers along the “leading edge” (upper left) additionally push the exposed panel along the sloped floating surface into the Panel Flipping Module 90. The Side B Platen B2 is identical in construction to the Side A platen A2 except the leading edge for the panel faces right.

Platen Lift Mechanism

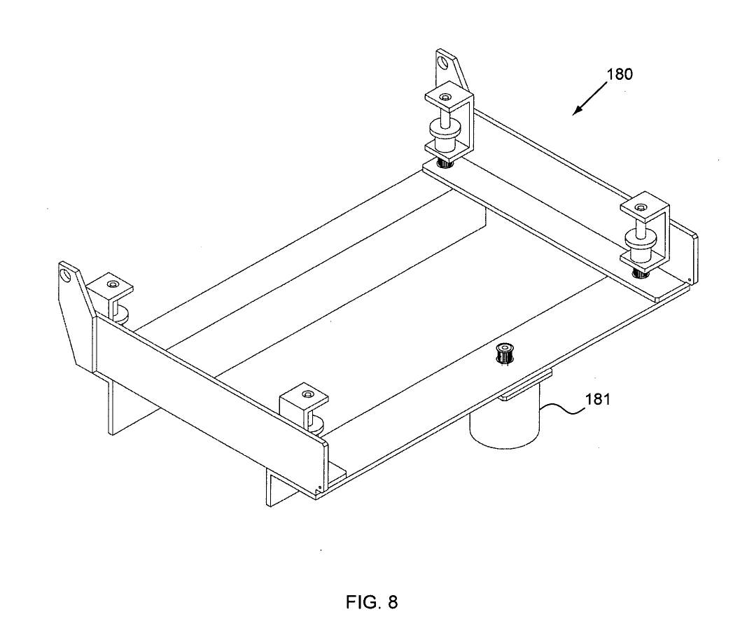

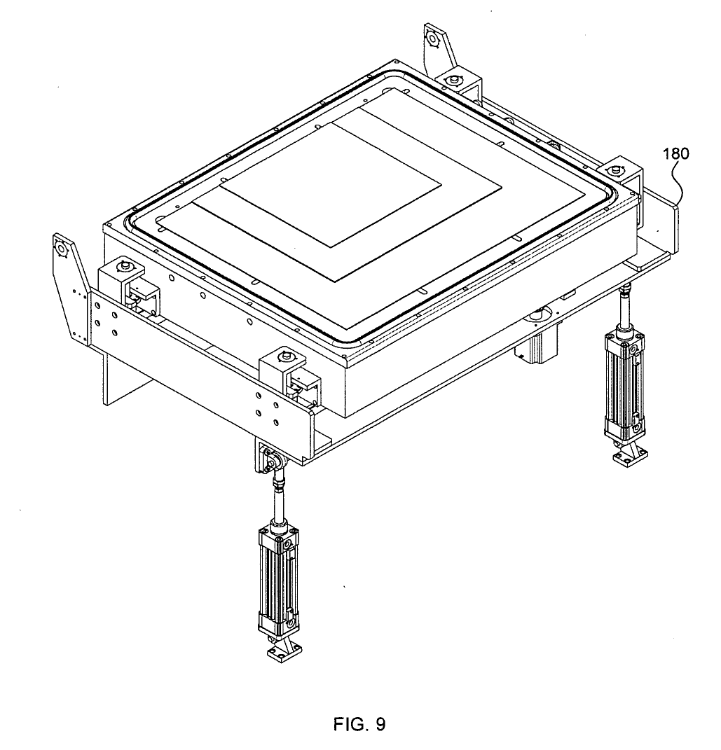

After the Panel Platen A2 has accepted a PCB from the Infeed Roller A1, and securely vacuumed it in place, the Platen Lift Mechanism 180 rotates the platen to the horizontal position about a pivot point and then lifts it about 50 mm (2 inches) to be in close proximity to the Artwork and Alignment System. The approximately 5 degree rotation is accomplished by pneumatic cylinders positioned opposite a pivot point, while a motor driven lift assembly provides a parallel motion to place the PCB at the correct height for alignment and exposure. FIG. 8 illustrates the motor 181 that drives a belt to lift all four corners of the platen uniformly to insure proper contact and planarization for the panel. FIG. 9 further illustrates the platen lift mechanism 180 holding a platen.

It is important to note that all the mechanics are positioned below the panel and Artwork to significantly reduce particle generation in the material path. During the alignment process, the Platen Lift Mechanism 180 lowers the PCB to an “off contact” position so that after camera vision inspection, the artwork can be moved to bring the targets to an acceptable tolerance for imaging. The platen lift mechanics then move upward again to bring the panel and artwork into intimate contact so that the cavity can be fully evacuated and the panel exposed. When the system completes the UV exposure for Side A, the vacuum is turned off, the air float system is enabled, and the Platen Lift Mechanism 180 will then return the platen A1 to the transport position and tilt it 5 degrees for the next movement into the Panel Flipping Module 90. Movements for the Side B Platen B2 are identical except the panel is expelled horizontally onto the Outfeed Roller B1 (without the 5 degree tilt to provide initial panel movement onto the rollers).

### Panel Chamber Vacuum System

As described above, a vacuum chamber is used to provide a flat, intimate contact between the photolithographic artwork to the PCB panel. In prior systems, production slow-downs are typically encountered during imaging caused by the inherent delays programmed by the operator to assure that the Chamber Vacuum has provided sufficient contact with the PCB to guarantee acceptable exposures. Most prior systems pull an initial vacuum level quickly enough, but the process of evacuating the small spaces between the PCB and artworks for acceptable yields takes considerable time. This occurs because, once initial contact is attained, there is an insufficient flow orifice to the vacuum pump remaining to quickly accomplish the task. In other words, the vacuum flow orifice(s) are so small, when the PCB panel is brought close to the artwork, the small orifices are further blocked, reducing the effective flow rate.

The present system therefore has a specially designed vacuum system and method that utilizes the region under the platen vacuum chuck as a high flow plenum to pull the required vacuum much more quickly.

In further detail, as illustrated in FIG. 10, each platen A2, B2 incorporates a high flow vacuum pump 84 that draws vacuum with significantly higher flow rates compared to conventional systems plus large flow paths to speed up the vacuum draw and release steps. Specifically, the pumps for chamber vacuum 84 and panel holding 85 are external to the platen and the hoses are connected to the bottom of the platen.

After a PCB 100 is centered, it is securely held in place by a perforated vacuum plenum (supplied by pump 85) via perforated holes 79 in top surface of the platen (the air float supply system 86 is de-activated, and the panel hold vacuum supply 85 is activated). If desired, the holding panel holding vacuum may comprise a plurality of different zones, to accommodate different sized panels. The auto shims 71-78 are moved into a position level with the top surface of the PCB 100.

An inflatable seal 44 raises to the glass that holds the artwork (not shown), and seals the platen against the glass. The enclosed/sealed area 82 inside the platen is vented to atmosphere by a switchable large orifice valve 83 until a chamber vacuum is required, and then the valve 83 is shuttled to seal the plenum (area) below the platen plate. The large orifice valve 83 then connects the plenum to the high flow vacuum pump 84. The high flow pump 84 pulls a vacuum down through the centering slots (i.e. slots 80, 81, 91, 92 used by the snubbers 51-56) and the area around the shims in the platen plate for a quick and uniform drawdown. Separate valves could be used for venting and pulling vacuum, if desired. The large orifice valve preferably has ports at least 1 (25 mm) to 2 (50 mm) inches in diameter, and in a preferred embodiment, the valve has 1½ inch (38 mm) ports. In one embodiment, the high flow pump 84 is capable of pulling 100-150 cfm of air from the plenum area under the platen surface. Note that even when the PCB panel and the artwork glass are brought together, there are still large areas (slots, holes) to pull vacuum, in contrast to prior art systems.

Once the PCB is exposed, the enclosed/sealed area 82 is again vented to atmosphere. Since the platen surface contains rather large slots 80, 81, 91, 92 and other openings, the vacuum is quickly removed, providing for faster system operation. After the exposure process is complete, the panel hold vacuum supply system 85 is de-activated and the air float supply system 86 is reactivated in the platen, to re-float the substrate.

### Panel Flipping Module

The Panel Flipping Module 90 is initially positioned behind, at the same height, and parallel to the 5 degree sloped surface of Platen A2. The top and bottom interior surfaces are filtered air bearings so that the panel slides quickly without scuffing when Platen A2 moves the panel into it. In other words, both interior sides of the panel have an air cushion to separate the panel faces from the surfaces of the Panel Flipping Module 90. The air can be supplied by the air float system pump 86 which supplies air to the platens and/or additional air float system pumps can be utilized. The panel is guided by the same type of snubber mechanisms as used in the Infeed Roller A1 and Platen A2 modules to maintain its centered pre-aligned position for the forthcoming rotation.

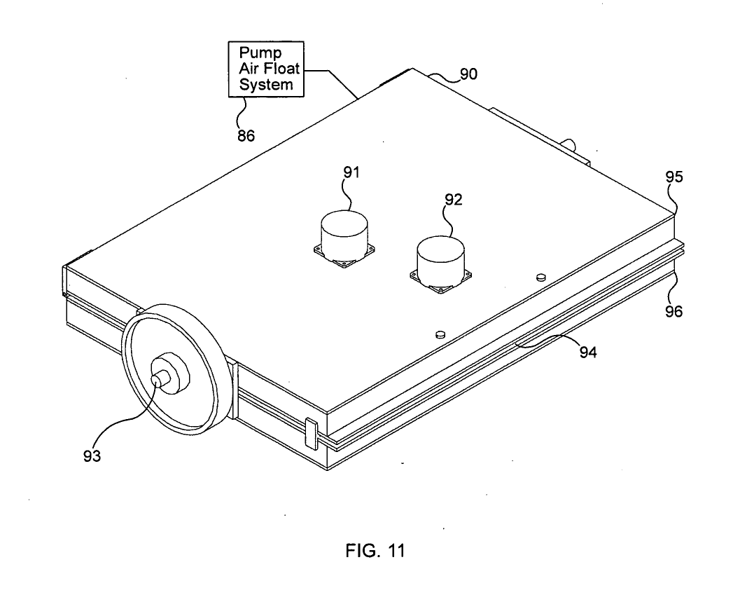

FIG. 11 illustrates the snubbing motors 91, 92 and the module's motor rotation pivot point 93. Once the floating panel is located in the panel slot 94, it is restrained between the top and bottom surfaces 95, 96 via the air cushions and the snubber bars. The entire Panel Flipping Module 90 extends upward about 125 mm (5″) by pneumatic cylinders and is then rotated 180 degrees. This places the panel in position to enter Platen B2 just as it entered Platen A2, except the panel is rotated 180 degrees. Now the leading edge of the panel is facing to the right (mirror image).

The rear snubbing mechanism within the flipper module then pushes the PCB panel onto Platen B2 in the same fashion as described with respect to Platen A2.

During its hold time in the Panel Flipping Module 90 the panel is cooled by clean, filtered air so that the PCB panel does not transfer heat to Side B's artwork, and is also cooled during the transportation process. After the PCB panel is taken by the Side B Platen B2, The Panel Flipping Module 90 returns to its home position in position to accept another panel from Platen A2.

### Artwork Holder and Alignment System

Each exposure station has an Artwork Holder and Alignment System 110 that manually slides out for cleaning and maintenance. This system houses a photo tool film holding (grooved) normally tempered glass plate 120 in a motorized stage that allows the manufacturer's film artwork to be aligned with targets on a PCB. There are three precision actuators that move the stage by moving in X (125)-Y1 (126)-Y2 (127) directions to correctly accomplish alignments.

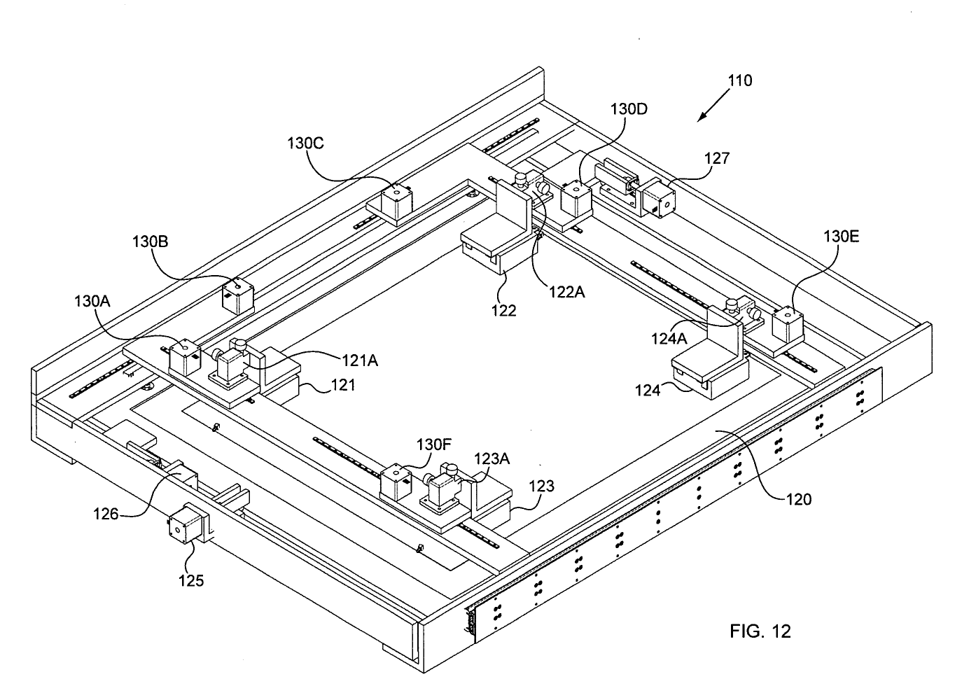

Each Artwork Holder and Alignment System 110 has four programmable motor driven CCD or CMOS cameras 121, 122, 123, 124 with illuminators selected with a specific wavelength so that they do not pre-expose the photo sensitive film during the alignment process. These illuminators are integrated into a machine vision system to determine precisely balanced centering of the artwork image to the PCB panel. FIG. 12 additionally shows the cameras mounted on the Artwork Holder and Alignment System 110.

The cameras/illuminators 121, 122. 123, 124 move independently via six motors 130A-F (6 axes of movement) to pre-programmed target positions on rails and also move out of the way when an exposure is started. Note that the cameras are not totally independent since that would involve 8 axes/motors and considerably more complexity and cost for a base apparatus, but such a device could be constructed if desired. Additionally, each camera may have a manual X-Y-Z adjustment system 121A, 122A, 123A, 124A for use when the machine is initially set up, or when cameras move out of alignment. Each camera's focal distance and initial location is manually set during the initial machine set up using these manual adjustment systems 121A, 122A, 123A, 124A, and can be adjusted as required with minimal disruption of the exposure process.

The apparatus features a manual artwork loading process. An operator places a film artwork on the Platen vacuum chuck over two “artwork install pins”, and then the machine moves the film into contact with the photo tool glass. The cameras inspect the locations and then automatically move the holder so the targets are centered in the fields of view. The artwork vacuum pump is always activated during a specific part number run, so that registration is never lost. Set-up times for both the artworks for both sides A and B should be less than two minutes including subsequent cleaning with a tacky roller.

### Tooling for Artworks

In most aspects, the present system is designed to be universally tooled. The artworks are plotted and can be hand punched to provide rough operator loading accuracy for the machine to automatically register the films in place. The unit's glass is clamped in place and does not require holes or bushings other than the fittings bonded to the vacuum grooves that connect to the artwork vacuum pump. The chamber vacuum (inflatable) seal contacts the glass directly which eliminates the forces around the perimeter of the glass during exposure. The only features on the glass are the vacuum grooves used to hold the artworks themselves. It is expected that since the panels are securely vacuumed down to the platen during the exposure process, glass panel pushers are not required.

Those skilled in the art will appreciate that various adaptations and modifications of the just-described preferred embodiments can be configured without departing from the scope and spirit of the invention. Specifically, while the present system has been described with respect to certain specific embodiments, more or less modules, controllers, pumps, valves, etc. can be utilized without departing from the present invention. Therefore, it is to be understood that, within the scope of the appended claims, the invention may be practiced other than as specifically described herein.

What is claimed is:

1. An automatic substrate transport and exposure system comprising:
a first platen, the first platen having holes on a top surface to allow forced air to produce an air film to support a substrate;
a flipper module configured to receive a substrate from the first platen, and to rotate in order to flip the substrate, the flipper module having a top interior surface and a bottom interior surface, wherein the top and bottom interior surfaces have holes to provide an air film to support the substrate in the flipper module; and
a second platen configured to receive the substrate from the flipper module, the second platen having holes on a top surface to allow forced air to produce an air film to support the substrate.

2. The system of claim 1, wherein the holes on the top surface of the first platen are also used to provide a panel hold vacuum.

3. The system of claim 1, wherein the holes on the top surface of the second platen are also used to provide a panel hold vacuum.

4. The system of claim 1, further comprising a first platen lift mechanism to lift the first platen into position for exposure.

5. The system of claim 4, further comprising a second platen lift mechanism to lift the second platen into position for exposure.

6. The system of claim 5, further comprising a first artwork holder and alignment system to hold and align photolithographic artwork to the substrate.

7. The system of claim 6, further comprising a second artwork holder and alignment system to hold and align photolithographic artwork to the substrate.

8. The system of claim 7, further comprising a first vacuum system to apply a vacuum to the first platen to bring the substrate and artwork close for exposure.

9. The system of claim 8, further comprising a second vacuum system to apply a vacuum to the second platen to bring the substrate and artwork close for exposure.

10. The system of claim 9, further comprising a first ultraviolet (UV) lamp exposure system to provide UV light energy to the substrate.

11. The system of claim 10, further comprising a second ultraviolet (UV) lamp exposure system to provide UV light energy to the substrate.

12. The system of claim 11, further comprising an infeed transport roller to transport substrates to the first platen.

13. The system of claim 12, further comprising an outfeed transport roller to transport substrates from the second platen out of the system.

14. The system of claim 12, wherein the infeed transport roller comprises one or more stops and two or more snubbers to align the substrate for handling by the first platen.

15. The system of claim 1, wherein the first and second platens comprise two or more retractable snubbers to align the substrate.

16. The system of claim 15, wherein the first and second platens are tilted about 5 degrees downward to provide gravity movement to receive the substrate.

17. An automatic substrate transport system comprising:
a first platen, the first platen comprising an air film system to generate an air film to support a substrate;
a flipper module configured to receive a substrate from the first platen, and to rotate the platen 180 degrees, the flipper module comprising an air film system to generate an air film on both sides of the substrate to support the substrate in the flipper module; and
a second platen, the second platen comprising an air film system to generate an air film to support the substrate;
wherein a substrate handled by the first platen, the flipper module and I the second platen is transported through the system substantially on a film of air.

18. A method for automatically transporting substrates through a light exposure system, the method comprising:
conveying a substrate to a first platen;
providing an air film to support the substrate in the first platen, such that the substrate is not substantially touching the surface of the first platen;
conveying the substrate from the first platen to a flipper module;
providing an air film on a top and a bottom interior surface of the flipper module to support the substrate;
rotating the flipper module to flip the substrate 180 degrees;
conveying the substrate to a second platen;
providing an air film to support the substrate in the second platen, such that the substrate is not substantially touching the surface of the second platen; and
conveying the substrate out of the system;
wherein the substrate is transported through the system substantially on a film of air.

19. A method for transporting substrates through an ultraviolet light exposure system, the method comprising:
activating an air float system;
receiving a substrate;
pre-aligning the substrate;
conveying the substrate to a first platen, wherein the first platen provides an air float to support the substrate;
aligning the substrate in the first platen and then de-activating the air float system, activating a vacuum hold down system;
lifting the first platen into position for exposure;
aligning artwork with the substrate;
applying a vacuum between the substrate and artwork;
exposing the substrate to ultraviolet light;
de-activating the vacuum systems and re-activating the air float system;
removing the vacuum;
lowering the first platen;
conveying the substrate from the first platen to a flipper module, wherein the flipper module provides an air film on a top and a bottom interior surface to support the substrate;
flipping the substrate 180 degrees;
conveying the substrate to a second platen, wherein the second platen provides an air float to support the substrate;
aligning the substrate in the second platen then de-activating the air float system, and activating a vacuum hold down system;
lifting the second platen into position for exposure;
aligning artwork with the substrate;
applying a vacuum between the substrate and artwork;
exposing the substrate to ultraviolet light;
removing the vacuums and activating the air float system;
lowering the second platen; and
conveying the substrate out of the system;
wherein the substrate is transported through the system substantially on a film of air.

20. An automatic substrate transport and exposure system comprising:
an air float supply system;
a first platen connected to the air float supply system, the first platen having holes on a top surface to allow air from the air float supply system to create an air film to support a substrate;
a flipper module connected to the air float supply system, the flipper module configured to receive a substrate from the first platen, and to rotate in order to flip the substrate, the flipper module having a top interior surface and a bottom interior surface, wherein the top and bottom interior surfaces have holes to allow air from the air float supply system to create an air film to support both sides of the substrate in the flipper module; and
a second platen connected to the air float supply system, the second platen configured to receive the substrate from the flipper module, the second platen having holes on a top surface to allow air from the air float supply system to create an air film to support the substrate.

21. The system of claim 20, further comprising a panel hold vacuum supply system connected to the first and second platens to provide a vacuum to hold a panel on the first and second platens during an exposure process, wherein the air float supply system and the panel hold vacuum supply both utilize the holes in the top surface of the platen.
